(19) United States
(12) Patent Application Publication
(10) Pub. No.: US 2010/0076623 A1
(43) Pub. Date: Mar. 25, 2010

(54) BRAKING PROCESS FOR AN AIRPLANE

(75) Inventor: Xavier Lamoussiere, Toulouse (FR)

Correspondence Address: Perman & Green, LLP, 99 Hawley Lane, Stratford, CT, 06614, US

(73) Assignee: AIRBUS FRANCE, Toulouse (FR)

(21) Appl. No.: 12/409,751

(22) Filed: Mar. 24, 2009

(30) Foreign Application Priority Data
Mar. 25, 2008 (FR) 08 51889

(51) Int. Cl. G05D 1/00; B64C 25/42

(52) U.S. Cl. 701/3

(57) ABSTRACT

An aircraft braking adaptation process is used to prevent rapid derotation of an aircraft causing damage to the front landing gear by formulating a braking command, applying the command to at least one brake, adapting the braking command by acquiring the aircraft trim and modifying the braking commands as a function of the aircraft trim.

This process limits the derotation speed and preserves the front landing gear.

### CROSS-REFERENCE TO RELATED APPLICATIONS

This application claims priority to French Application No. 08 51889, filed on 25 Mar. 2008, the disclosure of which is incorporated by reference herein in its entirety.

### BACKGROUND

1. Field

The subject of the disclosed embodiments is an improved aircraft braking process.

The field of the disclosed embodiments is aviation and, more specifically, aircraft. More specifically, the field of the disclosed embodiments is aircraft braking systems.

One goal of the aspects of the disclosed embodiments is to improve aircraft braking quality. Here, quality is understood to mean both the effectiveness of the braking and the comfort of the people onboard the aircraft during the braking phase.

Another goal of the aspects of the disclosed embodiments is to protect the front landing gear of the aircraft.

2. Brief Description of Related Developments

In the state of the art, during landing, the wheels of the main landing gear of an aircraft with so-called “tricycle” landing gear, i.e., rear landing gear, located behind the center of gravity of the aircraft, touch the ground before the wheel or wheels of the front landing gear, and do so with more or less of a time shift, depending on the trim of the aircraft and the speed of the stall. If the pilot gives the braking command before the main landing gear touches down, or very quickly thereafter, the pressure can be controlled in the brakes, while the front landing gear is not yet in contact with the ground.

If this braking is sustained, i.e., done at the aircraft's maximum braking capacity, the rapid rise in pressure in the brakes can cause major torque that will result in rapid derotation of the airplane, with a risk of overloading, and hence damaging the front landing gear. This damage can go as far as breakage in the worst cases.

The aspects of the disclosed embodiments solve this problem by adapting the aircraft braking based on its trim. The disclosed embodiments introduce weighting dependent at least on the aircraft trim into the braking control loop. This guarantees that maximum braking can be obtained only if the trim is such that all of the aircraft landing gear are in contact with the ground.

### SUMMARY

The purpose of the disclosed embodiments is, therefore, an aircraft braking process controlled by a command logic in the aircraft:
a step for formulating a braking command K,
a step for applying the command to at least one means of braking,
characterized by the fact that the process controlled by the aircraft command logic includes a step adapting the braking command K; said adaptation step includes the following steps:
acquisition of the aircraft trim A,
modification of the braking command into a braking command K' based on the aircraft trim A.

In one variation, the process in the disclosed embodiments is also characterized by the fact that the braking command is modified only if the difference between the trim A and a minimum trim Amin is greater than a predetermined threshold difference ΔS, so the maximum braking possibilities can be found again when the front wheel is close to the ground.

In one variation, the process in the disclosed embodiments is also characterized by the fact that the modification of the braking command is eliminated if the braking exceeds a predetermined period of time, so as not to reduce the braking possibilities when the aircraft is supposed to have reached a trim close to Amin, independently of the measured value of A.

In one variation, the process in the disclosed embodiments is also characterized by the fact that this elimination is degressive over a predetermined period of time.

In one variation, the process in the disclosed embodiments is also characterized by the fact that the elimination is linear in time.

In one variation, the process in the disclosed embodiments is also characterized by the fact that the adaptation of the braking command continuously combines, at each possible value A of the trim, a weighted coefficient P(A) of an initial braking command with the modified command K' then being the product of the initial command K times the weighted coefficient.

In one variation, the process in the disclosed embodiments is also characterized by the fact that P(A) has a value of one if the difference between the trim A and the minimum trim Amin is less than or equal to a strictly positive threshold difference ΔS, and P(A) takes a constant value strictly less than one in the other cases.

In another variation, the process in the disclosed embodiments is also characterized by the fact that P(A) has a value of one if the difference between the trim A and the minimum trim is less than or equal to a threshold difference ΔS, which can be positive or zero, and P(A) is a decreasing function of A starting with 1.

In one variation, the process in the disclosed embodiments is also characterized by the fact that the decrease is linear.

In another variation, the process in the disclosed embodiments is also characterized by the fact that the decrease is hyperbolic.

The braking process according to the aspects of the disclosed embodiments is advantageously used by an aircraft braking device with means of braking, and said means of braking include:
a logic for formulating a braking command,
a network for transmitting the braking command,
a braking device that can be controlled,
and in which in the formulation logic, or in the transmission network, the adaptation device includes:
circuits for acquiring the trim of the aircraft,
a logic for adapting the braking command based on the data produced by the aircraft trim acquisition circuits.

### BRIEF DESCRIPTION OF THE DRAWINGS

The aspects of the disclosed embodiments will be better understood by reading the following description and examining the figures accompanying it. They are presented for purposes of indication and are in no way limiting:

The figures show:

FIG. 1: an illustration of the device

FIG. 2: an illustration of the steps in the process

FIG. 3: an illustration of different weighted curves.

### DETAILED DESCRIPTION OF THE DISCLOSED EMBODIMENTS

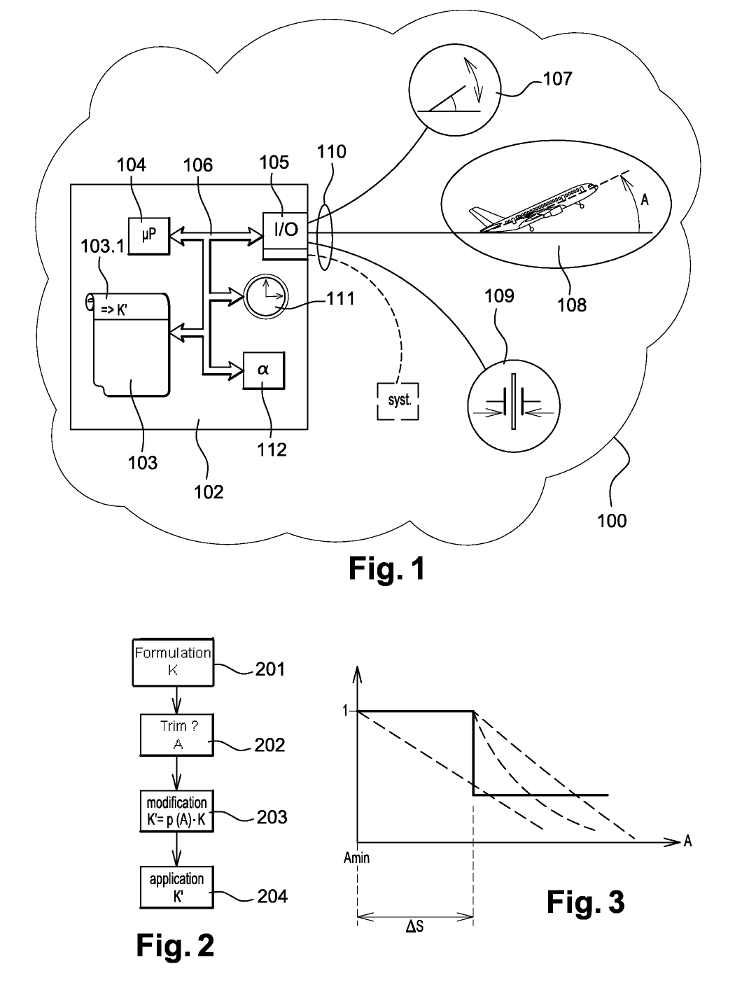

FIG. 1 is a schematic, functional view of certain elements of an aircraft 101. FIG. 1 shows, in particular, that the aircraft 101 has a logic 102 programmed according to instruction codes recorded in a memory 103. The programmed logic 102 is then designated as a processing device 102. The device 102 also has a microprocessor 104 and input/output circuits 105. Elements 103 to 105 are interconnected by a bus 106.

The device 102 is designated, in practice, by the term “calculator.”

The memory 103 has at least some instruction codes for implementing the process in the invention. These instruction codes are recorded in a zone 103.1 of the memory 103.

The circuits 105 allow the device 102 to be connected to the other communicating devices of the aircraft 101. For the invention, these communicating devices are at least:
a command interface device 107 for braking. It is with this device 107 that the pilot of the aircraft 101 controls the braking of said aircraft.
a device 108 for measuring the trim A of the aircraft. The trim A of the aircraft, when the aircraft is in contact with the ground, varies between a minimum value Amin, generally close to 0° and the value of the trim when the aircraft rests on the different landing gears in the static position, and a maximum trim value, most often a value limited by the aircraft geometry due to the presence of the ground. This is a measure of the pitch of the aircraft in relation to the plane formed by a landing strip. In one variation, the trim is considered minimal when a predetermined pressure is reached on the front landing gear of the aircraft. This pressure is the result of the front landing gear hitting the landing strip. In this variation, the trim measurement is therefore obtained by combining a pitch measuring device with a pressure measuring device on the front landing gear of the aircraft.
a braking system 109 controlled by the device 102. In practice, the device 102 produces a numerical command which is converted into a command, for example, an analog command, transmitted to at least one servo valve which in turn supplies the corresponding pressure to the aircraft brakes.

In this description, when an action is sent to a device, that action is in fact carried out by a microprocessor of said device controlled by instruction codes recorded in a program memory of said device.

FIG. 1 also shows that the device 102 is connected to other measurement systems on the aircraft. For example, these other systems are for, but not are not limited to
measuring the longitudinal speed of the aircraft,
measuring the longitudinal deceleration of the aircraft,
measuring the position of the aircraft landing gear,
measuring the velocity of the wheels,
measuring the pressure in the brakes,
. . .
   all figures that can be used in formulating a braking command.

FIG. 2 shows a step 201 for formulating a braking command K, called the initial command. This command is formulated on the instructions of an aircraft pilot who activates device 107. Device 107 then produces a signal that is forwarded to device 102 via a bus 110 to which are connected, if not all the aircraft's electronic systems, at least those cited so far.

Device 107 is connected to device 102 via an input of circuits 105 and the bus 110. If the signal produced by device 107 is analog, it is converted into a digital signal by the circuits 105 and placed at the disposal of the processor 104. This is then called the instruction signal Kc. Signal Kc varies as a function of the stress on the device 107 by the pilot of the aircraft.

In step 201, the device 102 produces an initial command signal K of the braking device 109. In the state of the art, this signal K is sent, via the bus 110, to the braking device 109. Device 109 then converts this command into a pressure in the braking system. The aircraft then slows down.

In the invention, the device 102 passes from step 201 to step 202 for aircraft trim acquisition. The trim is measured by device 102, which queries device 108 via the bus 110. In one variation of the invention, the device 108 constantly issues a measurement of the trim that is received and stored by device 102 in a memory, not shown. The trim measurement is therefore either requested from device 108 or read in a memory, which is itself regularly updated by data from device 108.

Device 102 passes from step 202 to step 203 to modify the initial command K with a view to producing a command K', called the modified command.

This modification is the type:

K′=p(A)·K

where A is a trim measurement and p is a function of A.

The result of p(A) is an interval number [0, 1]. Generally, the closer A is to the value Amin, the closer p(A) is to one.

There are several possible variations for the function p(A). FIG. 3 illustrates some of these variations.

FIG. 3 shows that one variation of function p(A) is a step function. p(A) has a value of “one” when the difference between A and Amin is less than a threshold value ΔS. For example, ΔS is 2°. If Amin exceeds ΔS, then p(A) has a value strictly less than 1, for example 0.5. In practice, a value between 0.2 and 0.8 is appropriate.

FIG. 3 shows that in one variation, the function p(A) is a function having a gradually decreasing zone.

p(A) has a value of “one” when the difference between A and Amin is less than a threshold difference ΔS. For example, ΔS is 2°. Then when the different A-Amin is greater than ΔS, p(A) decreases linearly from the value 1 to the value 0, which is reached for A being a value Amax, for example a value Amax between 16° and 20° representative of the maximum trim of an aircraft on the ground. In another variation, the decrease is hyperbolic. In still another variation, the decrease starts when A is worth Amin.

From step 203, the device 102 passes to a step 204 in which it sends the modified command K' to device 109, as it would have sent the initial command K before the invention.

In one variation of the invention, the device 102 has a clock 111 and a date memory 112. In this variation, the device 102 records in the memory 112 the starting date of the braking. Braking starts as soon as device 102 receives instructions from device 107. Device 102 thinks that braking is finished if there is a predetermined time interval within which it receives no instructions from device 107. This predetermined time interval is one second, for example. An absence of instructions is equivalent to no instructions.

In this variation, in step 203, the device 102 determines the amount of time since the braking started. This determination is done by calculating the difference between the date issued by the clock 111 and the date recorded in the memory 112. If this difference is greater than a predetermined threshold ΔSt, then step 203 is not implemented and then

K′=K

In one example, ΔSt is two seconds. In practice, ΔSt is in the interval of seconds.

In this variation, in order not to risk a sudden change in braking pressure, one variation provides for the initial command K to be re-established gradually. This means that p(A) is no longer modified according to the trim, but according to the time following a law like:

p(A,t)=p(A,t−1)+(1−p(A,t−1))/2

In other words, p(A) on the date t is a function of p(A) at the time of its preceding evaluation on date t−1. It is also a function of the difference between its value at its preceding evaluation and 1. This makes it possible to guarantee fast, but non-violent re-establishment of the maximum braking.

In one variation, the law of return to the initial command K is such that one passes from p(A, ΔSt) to 1 in a predetermined time. p(A, ΔSt) is the value of p(A) ΔSt seconds after the start of braking. This rise in p(A) is linear, parabolic, logarithmic or other.

The invention thus guarantees that there will be no fast derotation of the aircraft. It also guarantees that maximum braking is available at the end of a predetermined time.

What is claimed is:

1. An aircraft braking process that is controlled by an aircraft command logic comprising:
formulating a braking command K,
applying the command to at least one means of braking,
wherein the process is controlled by the aircraft command logic and includes modifying the braking command K, by:
acquiring the aircraft trim A, counted positively to nose up,
modifying the braking command based on the aircraft trim A into a braking command K′.

2. The process in claim 1, further comprising that the braking command is modified only if the difference between the trim A and a minimum trim Amin is greater than a predetermined threshold difference ΔSt.

3. The process in claim 1, further comprising that the modification of the braking command is eliminated if the braking exceeds a predetermined period of time.

4. The process in claim 3, further comprising that the elimination is done degressively over a predetermined period of time.

5. The process in claim 4, further comprising that the elimination is linear over time.

6. The process in claim 1, further comprising that the adaptation of the braking command continuously combines, at each possible value A of trim, a weighted coefficient P(A) of an initial braking command, and the modified command is then the product of the initial command times the weighted coefficient.

7. The process in claim 6, further comprising that P(A) has a value of “one” if the difference between the trim A and a minimum trim Amin is less than or equal to a strictly positive threshold difference ΔSt, and P(A) has a constant value strictly less than on in the other cases.

8. The process in claim 6, further comprising that P(A) has the value “one” if the difference between the trim A and a minimum trim Amin is less than or equal to a positive threshold difference ΔSt or zero, and P(A) is a decreasing function of A from a value of 1.

9. The process in claim 8, further comprising that the decrease is linear.

10. The process in claim 8, further comprising that the decrease is hyperbolic.
